(19) United States
(12) Patent Application Publication
(10) Pub. No.: US 2023/0152088 A1
(43) Pub. Date: May 18, 2023

(54) DEVICE FOR DETECTING A GEOMETRY OF A DROP ARRANGED ON A SAMPLE SURFACE

(71) Applicant: KRÜSS GmbH, Wissenschaftliche Laborgeräte, Hamburg (DE)

(72) Inventors: Alexander Buchholz, Norderstedt (DE); Bernd Friedrich, Hasloh (DE); Arne Kordts, Hamburg (DE); Timo Fuckner, Hamburg (DE)

(73) Assignee: KRÜSS GmbH, Wissenschaftliche Laborgeräte, Hamburg (DE)

(21) Appl. No.: 17/984,517

(22) Filed: Nov. 10, 2022

(30) Foreign Application Priority Data
Nov. 17, 2021 (WO) 21208702.7

(51) Int. Cl. G01B 11/24; G01B 11/02

(52) U.S. Cl. CPC G01B 11/24; G01B 11/026

(57) ABSTRACT

A device for detecting a geometry of a drop arranged on a sample surface includes a metering apparatus comprising a liquid reservoir and an outlet opening and a plurality of light sources configured to direct light onto a surface of the drop of liquid. A camera is configured to detect a reflection of the light from the surface of the drop of liquid. The device includes a housing including a recess that forms a cavity that is configured to be separated from external surroundings when the housing is arranged on the sample surface. The plurality of light sources are arranged in the cavity and cover a solid angle of at least π/2 sr when viewed from a point on the sample surface. At least a portion of the metering apparatus is positioned inside the cavity.

### CROSS REFERENCE TO RELATED INVENTION

This application is based upon and claims priority to, under relevant sections of 35 U.S.C. § 119, European Patent Application No. 21208702.7, filed Nov. 17, 2021, the entire contents of which are hereby incorporated by reference.

### TECHNOLOGICAL FIELD

The invention relates to a device for detecting a geometry of a drop arranged on a sample surface. By detecting a geometry of a drop of a known liquid on a sample surface to be characterized, it is possible to draw conclusions on the properties of the sample surface, because these properties determine the interaction with the applied liquid.

### BACKGROUND

A geometric property of the drop frequently used in this context is the so-called contact angle, which is formed when a defined test liquid comes into contact with the sample surface. To determine the contact angle, the document DE 197 54 765 C1, for example, discloses a device by means of which a shadow image of the drop is recorded from a sideways viewing angle. The contour of the drop and the interface with the sample are visible in the shadow image, and therefore the contact angle can be derived directly from the shadow image.

EP 2 093 557 B1 discloses a device to determine a contact angle, the drop is viewed from above by means of a camera. Two or three light sources are arranged at a lateral distance from an optical axis of the camera on which the drop must be located. Images of the light reflections of the light sources are detected by means of the camera. The distance from the associated image points to the optical axis or between the associated image points is evaluated. If the distance from the sample surface is known, the radius of the drop can be calculated based on this distance information.

U.S. Pat. No. 9,423,245 B2 discloses a device for measuring the surface contour of objects having reflective surfaces. The device comprises two cameras and one fluorescent screen, which surrounds the object in a semicircle. The cameras detect a reflection of a changing brightness distribution generated by the fluorescent screen.

WO 2020/176394 A1 discloses a device for measuring the surface geometry of optical components, wherein the reflection of a brightness distribution shown on a screen is detected at the optical component by means of a camera. In order to cover a large solid angle range, the optical component is arranged on a movable sample table and rotated stepwise between multiple, successive recordings.

### BRIEF SUMMARY OF THE INVENTION

Proceeding from this, the object of the invention is to provide a device by means of which a geometry of a drop arranged on a sample surface can be detected in a particularly simple manner and in a wide range of application scenarios.

a device configured to detect a geometry of a drop arranged on a sample surface comprises a housing having a recess which forms a cavity separated from the surroundings when the housing is arranged on a flat sample surface. The device further includes a metering apparatus which is configured to arrange liquid in the form of a drop on the sample surface. The metering apparatus comprises a liquid reservoir and an outlet opening arranged inside the cavity. The device further includes a plurality of light sources which are arranged in the cavity, wherein the light sources cover a solid angle of at least π/2 sr when viewed from a point on a flat sample surface, and a camera which is configured to detect a reflection of the light sources on the surface of the drop.

By means of the device, the geometry of the drop can be determined by determining points on the drop surface on the basis of the reflections of the light sources detected by the camera and the known locations at which the light sources are arranged. In this way, a contact angle of the drop, in particular, can be determined. The specific manner in which this evaluation is carried out is described in the document EP 3 910 314 A1. The entire content of this document is incorporated in this application. The disclosed device can also be referred to as a measuring head. It may be connected to an evaluation apparatus via a suitable data connection, wirelessly or by wire.

In an embodiment, the housing is arranged on the surface of a sample for the intended use of the device. In the simplest case, this is done by placing the housing on a sample, wherein the arrangement of the housing relative to the sample can be predetermined by means of defined contact surfaces on the housing. The housing may, in particular, comprise three contact points which are arranged on an underside of the housing and which can be brought into contact with the sample surface in order to arrange the housing at a defined position relative to the sample surface. If the sample surface is flat or almost flat, the cavity located between the housing and sample surface in the region of the recess is separated from the surroundings. This means that the cavity is at least partially shielded from light incident from outside that could impair the measurement. The cavity does not have to be completely or even hermetically sealed off and, in the case of samples that do not have a completely flat surface, this is generally not possible in the first place. In particular, this includes an arrangement in which there is a gap of, for example, a few millimeters between the housing and the sample surface, which is unproblematic in most cases.

After the housing has been arranged on the sample surface, a liquid drop can be applied onto the sample surface by means of the metering apparatus. This is done via an outlet opening arranged inside the cavity, regardless of the design of the metering apparatus. As a result, the subsequently provided detection of reflections of the light sources on the drop surface by means of the camera can begin immediately after the drop has been applied, in particular without the arrangement of the housing on the sample surface having to be changed beforehand.

In an embodiment, the light sources are located inside the cavity and are arranged so as to be fixed relative to the housing. The light sources are configured such that the geometry of the drop surface can be determined as precisely as possible based on the reflections, detected by the camera, of the light emitted by the light sources. For this purpose, the light sources are ideally punctiform. In practice, the light sources have a limited spatial extent that should nevertheless be dimensioned in such a way that each light source is spaced apart from all adjacent light sources and appear clearly separate therefrom in the image of the camera.

The disclosed device may be implemented with different numbers of light sources. In general, the geometry of the drop can be detected more precisely with a larger number of light sources, however too many light sources pose the risk that individual light reflections can no longer be reliably assigned to individual light sources. For example, it is possible to work with at least 5, at least 7, at least 10, at least 15, at least 20, at least 30, or at least 40 light sources. In practice, a number in the range of from 40 to 200 light sources has proven effective.

Furthermore, the light sources are arranged such that they cover a solid angle of at least π/2 sr, specifically when viewed from a point on a flat sample surface. Said point may, in particular, be arranged where a drop is applied by means of the metering apparatus. In any case, the point from which the solid angle coverage of the light sources is viewed is located in the plane in which a flat sample surface is located when the housing is arranged on said sample surface. The location of this plane can be determined using the geometry of the device, in particular using contact surfaces or contact points of the housing. In particular, said location may coincide with an underside of the housing. The fact that the light sources cover a specific solid angle means that a surface defined by the arrangement of the light sources appears at said solid angle from said point. The surface may, in particular, have a border line that encloses all light sources and is formed by means of straight-line connections between adjacent light sources arranged furthest out. In the invention, said solid angle is at least π/2 sr, but may preferably also be at least π sr or at least 3/2 π sr, i.e. it may extend over approximately the entire half-space (corresponding to a solid angle of 2 π sr) above the sample surface.

Furthermore, the disclosed device may comprise a controller for controlling the light sources, wherein the controller may, in particular, be designed to switch the light sources on and off individually and/or in groups. By means of the disclosed device, it is possible to detect the geometry of a liquid drop in a very simple and, optionally, in a largely automated manner. One factor contributing to this is that a cavity that is shielded from the surroundings is created by means of the housing having the recess. By integrating a camera, a metering apparatus, and light sources in the device, the measurement can take place in a very simple manner and, if desired, in a partially or fully automated manner inside this separated cavity.

Because the light sources are arranged so as to be distributed over a large solid angle, drops with any contact angle can be measured. As a result, the disclosed device does not need to be adjusted or otherwise adapted to different application scenarios or alternatively this can also be done automatically, for example by controlling specific light sources in a targeted manner.

In one embodiment, the light sources comprise multiple first light sources and multiple second light sources, wherein the first light sources are smaller and/or are arranged at shorter distances from one another than the second light sources. As a result, it is possible to work with two different groups of light sources that are optimized for different applications. In the case of drops that have small contact angles, the drop surface is less curved than in the case of drops having larger contact angles. The solid angle range from which light is detected by the camera by means of reflection on the drop surface is therefore much smaller in the case of small contact angles than in the case of large contact angles. Therefore, in order to detect the geometry in a precise manner, it is important to arrange a sufficient number of light sources within the relevant solid angle range. As such, it is sensible to arrange the first light sources at relatively short distances from one another and to design the first light sources themselves to be relatively small. However, in the case of large contact angles, it is sensible to use the second light sources, which are arranged at larger distances from one another and which may themselves also be designed to be larger than the first light sources. In particular, the first light sources may be arranged such that the solid angle range which is viewed from a point on a flat sample surface and which is covered by the first light sources is not larger than π/4 sr. In particular, the solid angle range may be in the range of from 1/16 π sr to π/4 sr. In particular, it is possible to work with at least 5 first light sources and at least 5 second light sources, at least 10 first light sources and at least 10 second light sources, at least 15 first light sources and at least 15 second light sources, or at least 20 first light sources and at least 20 second light sources.

In one embodiment, the first light sources are arranged such that they are imaged on a sensor of the camera by means of reflection on a reflective, flat sample surface on which the housing is arranged, and/or the second light sources are arranged such that they are not imaged on a sensor of the camera by means of reflection on a reflective, flat sample surface on which the housing is arranged. The first light sources are therefore arranged opposite the camera in relation to a perpendicular line. It is possible to check whether the arrangement of the light sources corresponds to the embodiment by arranging the housing on a mirror, for example. In this case, reflections of the light sources on the reflective, flat surface itself and not on the surface of a drop are detected by the camera. The second light sources are preferably arranged such that they are arranged outside the solid angle range reserved for the first light sources.

In one embodiment, the light sources or some of the light sources are arranged in a developable surface, in particular in a lateral surface of a cylinder or cone. In principle, the arrangement of the light sources in the cavity is arbitrary, provided that the required solid angle range is covered. For example, the recess may be hemispherical and/or the light sources may be arranged at a uniform distance from the drop on a spherical surface. However, this is constructively laborious, in particular because the light sources generally have to be fastened individually for this purpose. By arranging the light sources or some of the light sources in a developable surface, the light sources can be arranged on a suitable, planar substrate and subsequently brought into their final position by arranging the substrate in the developable surface.

In one embodiment, the light sources or some of the light sources are arranged on a flexible circuit board. A flexible circuit board is an example of a substrate which can be arranged in the developable surface after being equipped with the light sources. Production of the device is made much simpler by using a flexible circuit board, in particular in comparison to individually fastening the light sources. The flexible circuit board may, in particular, be glued on in a planar manner in order to fix the arrangement thereof relative to the housing, for example directly to a wall of the recess or to another substrate, for example a correspondingly bent metal sheet. Because the flexible circuit board is glued on in a planar manner, all light sources arranged on the flexible circuit board can be fixed in a precise and lasting manner, which is advantageous for precise detection of the geometry of the drop.

In one embodiment, control electronics for the light sources arranged on the flexible circuit board are arranged either on a non-curved part of the flexible circuit board or on a substrate other than the flexible circuit board that is connected to the flexible circuit board via electrical lines. For all above-described embodiments, discrete light sources, in particular LEDs, may for example be used as light sources, in conjunction with a flexible circuit board in particular in a surface-mounted design (SMD). Light sources of this kind may have very small dimensions in the order of, for example, 1 mm or less. On account of this miniaturization, relatively small radii of curvature are possible for the flexible circuit board. The control electronics provided for controlling the light sources generally have larger dimensions. In the case of the control electronics being arranged on the flexible circuit board, only a less pronounced curvature is possible, which can lead, inter alia, to larger distances between the light sources and the drop. Therefore, by outsourcing the control electronics, a compact design is possible for the device.

In principle, some of the light sources may be arranged in a flat surface, in particular on a rigid circuit board. For example, the recess may be equipped with light sources using multiple rigid circuit boards across the required solid angle range, for example four rigid circuit boards that are arranged on side walls of the recess, and one or two additional rigid circuit boards that are arranged on a ceiling of the recess.

In one embodiment, the light sources or some of the light sources are image points of a screen, in particular an OLED screen. In this way, the desired lighting situation can be created with one screen instead of many discrete light sources. Of course, discrete light sources may also be combined with a screen or two or more screens may be used. Individual image points of the screen may be illuminated for each light source or groups of image points that in each case form an illuminated surface may be illuminated.

In one embodiment, the light sources or some of the light sources emit infrared light. In principle, it is possible in the invention to work with light sources of any desired wavelengths, in particular in the visible range. The use of infrared light can reduce interference in conjunction with suitably selective cameras. Moreover, it is possible to reduce interfering reflections from inside the drop, which can occur, in particular, by means of reflection on the sample surface below the drop, because many liquids absorb infrared light to a greater extent than light of other wavelength ranges.

In one embodiment, the metering apparatus is configured to apply the liquid onto the sample surface as a continuous jet or a succession of droplets. Drop metering of this kind is known in the field of contact angle measurement and is characterized by a high speed and robustness.

In one embodiment, the metering apparatus is configured to transport the liquid onto the sample surface in a direction that extends substantially perpendicularly to the sample surface. On account of the transportation substantially perpendicularly to the sample surface, the drop can be applied by the metering apparatus in such a way that it assumes a largely symmetrical shape. If the transport direction deviates too much from the perpendicular, the drop in many cases acquires an undesired asymmetry. In practice, it is possible, in particular, to work with an angle in the range of from 75° to 105°, preferably in a range of from 80° to 100°, in particular in a range of from 85° to 95°. The liquid may be transported in the above-mentioned direction either as a continuous jet or a succession of droplets, but also using an established method in the field of contact angle measurement, wherein the drop is formed so as to be suspended from a metering apparatus and is deposited on the sample surface by moving the metering apparatus closer to the sample surface in the above-mentioned direction. In all cases, a particular advantage is that an optimal, symmetrical geometry of the drop is achieved by means of the perpendicular application.

In one embodiment, the outlet opening is formed at one end of a metering tube that protrudes into the cavity and/or the metering apparatus comprises a movable portion on which the outlet opening is arranged, wherein the movable portion can be completely or partially moved out of the cavity. In both cases, the cavity remains free from other components of the metering apparatus. This prevents the metering apparatus from shading light sources located in the field of view of the camera.

In one embodiment, the housing comprises an adapter fastened to the housing, wherein the adapter comprises a receiving portion for a sample with a defined geometry. By using an adapter of this kind, the housing can always be brought into a defined arrangement relative to a specific type of sample. In particular, various adapters that each comprise receiving portions for different, standardized sample geometries may be provided.

In one embodiment, the device comprises an additional camera which is configured to detect a reflection of the light sources on the drop surface, wherein the camera and the additional camera have different viewing directions. By virtue of this embodiment with two cameras, a larger number of light reflections is available for determining the geometry of the drop, because some or many, ideally all, of the light sources, are imaged by means of reflection on both cameras. The accuracy of the geometry detection can be improved as a result. The viewing directions of both cameras may differ from one another by, in particular, 10° or more.

In one embodiment, the device comprises a distance measuring apparatus for determining a distance between the device and a sample surface. The distance measuring apparatus may, in particular, comprise a laser, the light of which, which is directed onto the sample surface, is detected by the camera and/or by the additional camera. The laser may, in particular, be a cross laser. For many measuring tasks, it is advantageous if the distance between the sample surface and measuring device is known. In particular, deviations resulting from a non-flat sample surface can be taken into consideration by means of a distance measurement of this kind.

In one embodiment, the camera comprises a sensor having a sensor plane and a lens having a lens plane, wherein the sensor plane, the lens plane, and an object plane, which corresponds to a sample surface on which the housing is arranged, intersect in a common straight line. This special arrangement corresponds to the Scheimpflug principle and makes it possible for the entire sample surface to be imaged sharply on the sensor even in the case of a camera that is oriented obliquely to the sample surface.

An embodiment of a method for detecting a geometry of a drop arranged on a sample surface by means of the disclosed device includes arranging the housing on a sample surface. A liquid drop is applied on the sample surface by means of the metering apparatus and a reflection of the light sources on the drop surface is detected by means of the camera. In an embodiment, the light sources are arranged, in particular, such that they cover a solid angle of at least π/2 sr when viewed from the point on the sample surface at which the drop is arranged.

### BRIEF DESCRIPTION OF THE DRAWINGS

The invention is explained in greater detail below with reference to exemplary embodiments represented in figures, in which:

FIG. 1 schematically illustrates a cross-sectional representation of an embodiment of a device for detecting a geometry of a drop arranged on a sample surface; and

FIG. 2 is a photograph of another embodiment of the device for detecting a geometry of a drop arranged on a sample surface.

### DETAILED DESCRIPTION OF THE INVENTION

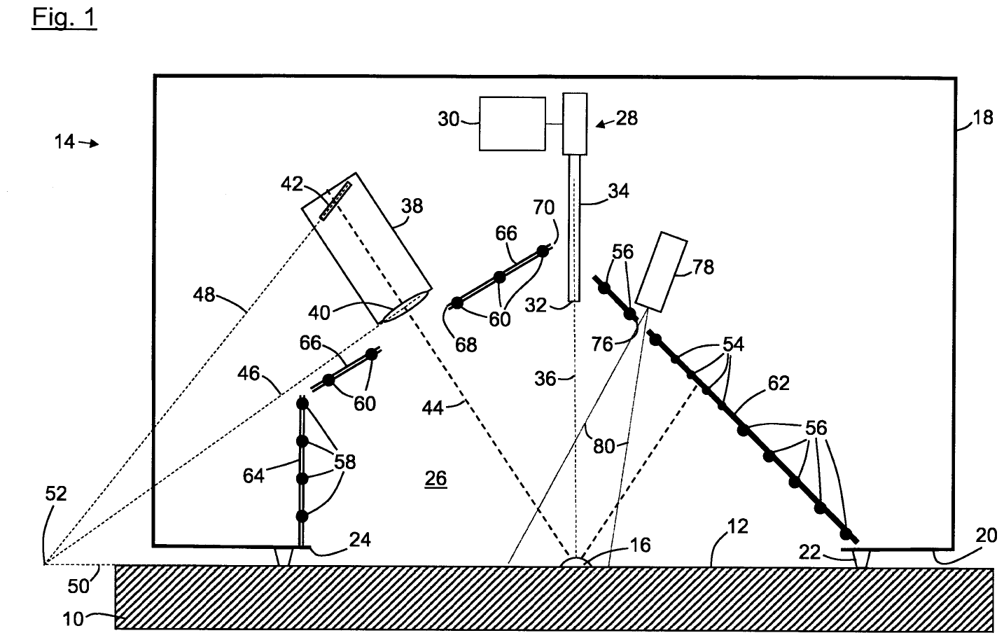

FIG. 1 shows a sample 10 having a flat sample surface 12 on which a device 14 is arranged. The device 14 serves to detect a geometry of a drop 16 arranged on the sample surface 12. The device 14 comprises a housing 18, on the underside 20 of which feet 22 are arranged, which feet each form a contact point and which are in contact with the sample surface 12 in the arrangement shown. The housing 18 is therefore in a defined position relative to the sample surface 12. The housing 18 comprises a recess 24, which is not shown in more detail in FIG. 1. When the housing 18 is arranged on the sample surface 12, said recess 24 forms a cavity 26 which is separated from the surroundings.

Moreover, the device 14 comprises a metering apparatus 28. The metering apparatus 28 comprises a liquid reservoir 30 and an outlet opening 32, which is arranged at a lower end of a metering tube 34 and protrudes into the cavity 26. By means of the metering apparatus 28, liquid can be applied onto the sample surface 12 in the form of a continuous jet from the liquid reservoir 30. The jet direction 36 is oriented approximately perpendicularly to the sample surface 12.

Moreover, the device 14 comprises a camera 38, which has a lens 40 and a sensor 42. A viewing direction 44 of the camera 38 is indicated by a dashed line and directed onto the drop 16. In the arrangement shown, the sensor 42 is located in a sensor plane 48, the lens 40 is located in a lens plane 46, and the sample surface 12 is located in an object plane 50. As schematically shown, the three planes 46, 48, 50 intersect in a common straight line 52 or point.

A plurality of light sources is arranged inside the cavity 26, including multiple first light sources 54 and multiple second light sources 56, 58, 60. The first light sources 54 are smaller than the second light sources 56, 58, 60 and are also arranged at shorter distances from one another than the second light sources 56, 58, 60.

The first light sources 54 and the second light sources 56 are arranged on a flexible circuit board 62, which is glued in a planar manner to a support part (not shown) of the housing 18. The flexible circuit board 62 extends along a lateral surface of an elliptical cylinder, which is not visible in the cross-section of FIG. 1.

The second light sources 58 are arranged on a first rigid circuit board 64 and the second light sources 60 are arranged on a second rigid circuit board 66. The second rigid circuit board 66 comprises a through-opening 68, behind which the camera 38 is arranged. An additional opening 70 is located between the flexible circuit board 62 and the second rigid circuit board 66. The metering tube 34 protrudes through said opening 70 and into the cavity 26.

The flexible circuit board 62 also comprises a through-opening 76, behind which a cross laser 78 is arranged. The cross laser 78 is arranged such that it projects a cross onto the sample surface 12 in the region of the drop 16, as indicated by the lines 80.

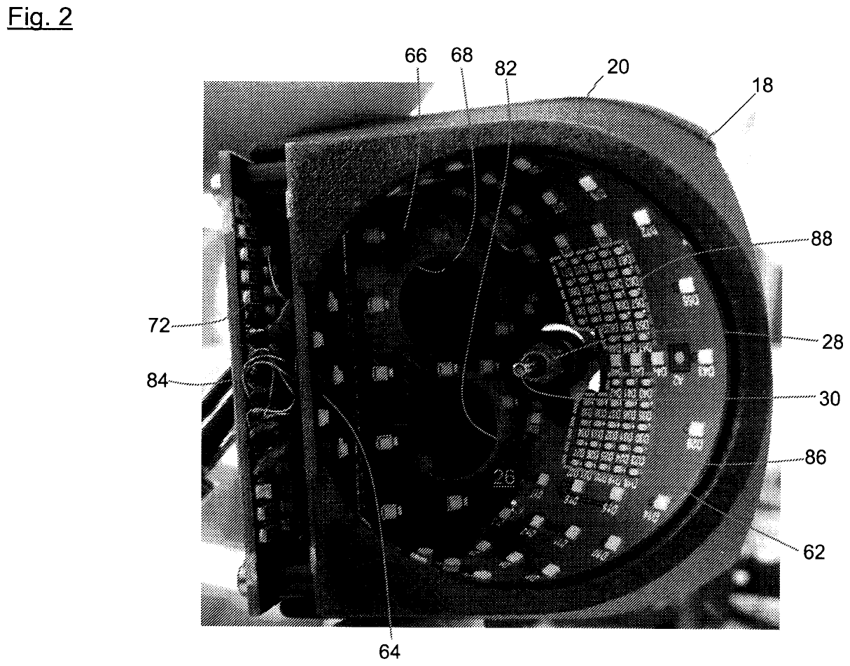

The recess 24 in the housing 18 is substantially lined by the first rigid circuit board 64, the second rigid circuit board 66, and the flexible circuit board 62. The cavity 26 above the sample surface 12 is approximately dome-shaped, wherein the first rigid circuit board 64 is oriented approximately perpendicularly to the sample surface 12 and the second rigid circuit board 66 forms a ceiling portion arranged obliquely with respect to the sample surface 12. The remaining wall surface of the recess 24 is covered by the flexible circuit board 62, which is more clearly visible in FIG. 2.

FIG. 2 shows an embodiment of a device that is configured to substantially correspond to the device 14 from FIG. 1. In particular, in this case, there is also a flexible circuit board 62, which is arranged on a developable surface, namely an elliptical cylinder lateral surface. A housing 18 having an underside 20 is also clearly visible. In the example of FIG. 2, the recess 24 formed in the housing 18 is also substantially lined by a first rigid circuit board 64, a second rigid circuit board 66, and the flexible circuit board 62. These three circuit boards 64, 66, 62 are arranged as described with reference to FIG. 1.

It can be seen in FIG. 2 that the second rigid circuit board 66 comprises two through-openings 68, 82. The camera 38 (not visible) is located behind the through-opening 68 and an additional camera (not visible either) is located behind the through-opening 82. The metering apparatus 28 having the metering tube 34 is also clearly visible.

Moreover, FIG. 2 shows an additional circuit board 84, which is arranged on the side of the first rigid circuit board 64 that is facing away from the cavity 26 and which contains control electronics (72). The first light sources 54 are arranged in two groups in a matrix-like manner. The first group 86, which is bordered by a dashed line, is arranged such that, when the housing 18 is arranged on a reflective, flat sample surface 12, the light emitted by the associated first light sources 54 is detected by the camera 38 behind the through-opening 68 after being reflected on the reflective surface. The same applies to the first light sources 54 of the second group 88, the light from which is reflected into the additional camera located behind the other through-opening 82.

Each of the groups 86, 88 of first light sources 54 extends over a solid angle range of approximately π/12 sr. The entirety of the first and second light sources 54, 56, 58, 60 extends over a solid angle range of approximately 3/2 π sr. In both cases, as explained, the solid angle range is viewed from a point on a flat sample surface 12, in particular from the point at which the drop 16 is applied.

### LIST OF REFERENCE SIGNS

10 Sample

12 Sample surface

14 Device

16 Drop

18 Housing

20 Underside

22 Foot

24 Recess

26 Cavity

28 Metering apparatus

30 Liquid reservoir

32 Outlet opening

34 Metering tube

36 Jet direction

38 Camera

40 Lens

42 Sensor

44 Viewing direction

46 Lens plane

48 Sensor plane

50 Object plane

52 Common straight line

54 First light source

56 Second light source

58 Second light source

60 Second light source

62 Flexible circuit board

64 First rigid circuit board

66 Second rigid circuit board

68 Through-opening

70 Opening

72 Control electronics

76 Through-opening

78 Laser

80 Lines

82 Through-opening

84 Additional circuit board

86 First group of first light sources

88 Second group of first light sources

1. A device for detecting a geometry of a drop arranged on a sample surface, comprising:
a metering apparatus comprising a liquid reservoir and an outlet opening, wherein the metering apparatus is configured to apply a drop of liquid on the sample surface;
a plurality of light sources configured to direct light onto a surface of the drop of liquid; and
a camera configured to detect a reflection of the light from the surface of the drop of liquid; and
a housing including a recess that forms a cavity, wherein the cavity is configured to be separated from external surroundings when the housing is arranged on the sample surface,
wherein the plurality of light sources are arranged in the cavity,
wherein the plurality of light sources cover a solid angle of at least π/2 sr when viewed from a point on the sample surface, and
wherein at least a portion of the metering apparatus is positioned inside the cavity.

2. The device according to claim 1, wherein the plurality of light sources comprise multiple first light sources and multiple second light sources, wherein the multiple first light sources are smaller than the multiple second light sources.

3. The device according to claim 1, wherein the plurality of light sources comprise multiple first light sources and multiple second light sources, wherein the multiple first light sources are arranged at shorter distances from one another than are the multiple second light sources.

4. The device according to claim 3, wherein the multiple first light sources are arranged such that they are imaged on a sensor of the camera by means of a reflection from the sample surface on which the housing is arranged.

5. The device according to claim 3, wherein the multiple second light sources are arranged such that they are not imaged on a sensor of the camera by means of a reflection from the sample surface on which the housing is arranged.

6. The device according to claim 1, wherein at least some of the plurality of light sources are arranged on a lateral surface of a cylinder or cone.

7. The device according to claim 1, wherein at least some of the plurality of light sources are arranged on a flexible circuit board that is coupled to the housing.

8. The device according to claim 7, further comprising control electronics configured to control the plurality of light sources positioned on the flexible circuit board.

9. The device according to claim 1, wherein at least some of the plurality of light sources are image points of an OLED screen.

10. The device according to claim 1, wherein at least some of the plurality of light sources emit infrared light.

11. The device according to claim 1, wherein the metering apparatus is configured to apply the liquid onto the sample surface as one of a continuous jet or a succession of droplets.

12. The device according to claim 1, wherein the metering apparatus is configured to transport the liquid onto the sample surface in a direction that extends substantially perpendicularly to the sample surface.

13. The device according to claim 1, wherein the outlet opening is formed at one end of a metering tube that protrudes into the cavity.

14. The device according to claim 1, wherein the metering apparatus comprises a movable portion on which the outlet opening is arranged, and wherein the movable portion is configured to be at least partially moved out of the cavity.

15. The device according to claim 1, wherein the housing comprises an adapter fastened to the housing and a receiving portion for a sample, wherein the receiving portion includes a defined geometry.

16. The device according to claim 1, further comprising an additional camera configured to detect a reflection of the light sources from the surface of the drop, wherein the camera and the additional camera comprise different viewing directions.

17. The device according to claim 16, further comprising a distance measuring apparatus configured to determine a distance between the device and the sample surface, wherein the distance measuring apparatus comprises a laser configured to direct a laser light onto the sample surface, and wherein the laser light is detected by at least one of the camera and the additional camera.

18. The device according to claim 1, wherein the camera comprises a sensor including a sensor plane, a lens including a lens plane and an object plane extending along the sample surface, wherein the sensor plane, the lens plane, and the object plane intersect in a common straight line.
